(19) United States
(12) Patent Application Publication
(10) Pub. No.: US 2012/0026407 A1
(43) Pub. Date: Feb. 2, 2012

(54) System and Method for Configurable Multi-standard Receiver

(75) Inventors: Yifeng Zhang, San Jose, CA (US); Rong Liu, Beijing (CN); Peiqi Xuan, Saratoga, CA (US); Xiaodong Jin, Saratoga, CA (US)

(73) Assignee: QUINTIC HOLDINGS, Santa Clara, CA (US)

(21) Appl. No.: 13/116,532

(22) Filed: May 26, 2011

Related U.S. Application Data
(60) Provisional application No. 61/369,676, filed on Jul. 31, 2010.

(51) Int. Cl. H04N 5/50; H04B 1/16; H04B 1/06

(52) U.S. Cl. 348/731; 455/255; 455/208; 348/E05.097

(57) ABSTRACT

A configurable multi-standard receiver. A receiver comprises a mixer, a processing module and an analog to digital converter is disclosed to receive multi-standard radio signals. The processing module includes a first selection switch and first parameter control, where the first selection switch configures the processing module as a complex filter or a real-valued filter and the first parameter control configures the characteristics of the filter. Furthermore, the analog to digital converted is preferably implemented using sigma delta modulation to achieve a desired noise shaping. The sigma delta modulation comprises a second selection switch and second parameter control. The second selection switch configures the sigma delta modulation to function as a unit having a complex loop filter or a unit having real-valued loop filters. The second parameter control configures the characteristics of the loop filter. The settings for the first and second selection switches and the first and second control parameters may be stored in a control register.

### CROSS REFERENCE TO RELATED APPLICATIONS

The present invention claims priority to U.S. Provisional Patent Application Ser. No. 61/369,676, filed Jul. 31, 2011, entitled “System and Method for Configurable Multi-standard Receiver”. The U.S. Provisional patent application is hereby incorporated by reference in its entirety.

### FIELD OF THE INVENTION

The present invention relates to radio receiver. In particular, the present invention relates to radio receiver configurable to receive multi-standard radio signals, such as analog television signals and digital television signals based on the unified architecture.

### BACKGROUND

In the field of consumer electronics, versatility has always been a desired feature. A single consumer product often provides multiple functions for convenience of use. For example, a consumer television receiver can receive analog TV and digital TV in many different formats such as NTSC, PAL, ATSC, QAM, and DVB-T. Similarly, a broadcast audio receiver may be desirable to receive AM, FM, and several digital audio signals such as DAB and HD Radio. Each type of signals may have very different characteristics and may need dedicated receiver circuits for proper operation according to a conventional implementation. For example, the analog television signals, such as NTSC and PAL, have asymmetric spectrum around the carrier frequency. The ATSC digital television based on VSB technology also has asymmetric spectrum around the carrier frequency. On the other hand, digital television signals in compliance with the DVB-T, ISDB-T and QAM modulation standards has symmetric spectrum around the carrier frequency. Furthermore, the same type of television signal may be transmitted using different frequency bandwidth in different regions. For example, the DVB-T signal may be transmitted at 6, 7 or 8 MHz bandwidth in various countries.

FIG. 1 illustrates a conventional approach to standard television receiver 100 where the receiver supports both analog TV and digital TV reception. In this example, both the analog and digital TV paths share the same analog front end circuit 110. Typically, the analog front end circuit comprises one or multiple stages of filters, and one of multiple stages of amplifier such as low-noise amplifier (LNA) and variable gain amplifier (VGA). Since the signal characteristics may be very different for different standards, different down-conversion/analog demodulation circuits 122 and 124 are often used. Usually the down conversion is be performed in a single stage or two stages to convert the high frequency incoming RF signal to a low IF or zero IF signal so that the down-converted signal can be benefitted from the digital signal processing technology for efficient and versatile processing by using a digital signal processing module 130. For digital TV signal, the DSP will provide digital data string to a subsequent digital audio/video decoder to reproduce the audio and video signals for viewing/listening or storage. The compressed data in the digital data string may also contain service data, such as Electronic Programming Guide (EPG) associated with the audio and video contents. The same DSP module 130 can also be configured to perform analog TV demodulation to take advantage of the flexible and powerful processing capability of the DSP module 130. In order to render the analog audio/video output suitable for interface available in existing TV sets, the demodulated audio and video signals have to be converted to the popular analog audio/video interface formats, such as composite video and stereo analog audio, using a video DAC 142 and an audio DAC 144.

As is noted in FIG. 1, both analog TV and digital TV may share the same system resource, such as the analog front end circuit 110, and DSP module 130 in this example to the take advantage of the flexibility of the DSP module. It would be beneficial to develop a down-conversion/analog demodulation circuit that is configured to support the requirement of processing multiple standards, such as various analog TV transmission formats, and digital TV formats at various bandwidths. Therefore, the same receiver resources may be configured to receive multi-standard signals, such as NTSC, PAL, ATSC and DVB-T.

### BRIEF SUMMARY OF THE INVENTION

According to one embodiment of the present invention, a multi-standard radio receiver is configured to operate in at least one operation mode, wherein the multi-standard radio receiver comprises a mixer, a processing module and an analog to digital converter (ADC). The mixer is coupled to an input signal and a local oscillation signal to provide a mixer output signal, wherein the mixer output signal comprises an in-phase signal and a quadrature signal. The processing module is coupled to receive the mixer output signal having a first control, wherein the first control configures the processing module based on the plurality of operation modes. The ADC having a second control is coupled to receive the signal processed by the processing module, wherein the second control configures the ADC based on the plurality of operation modes. In another embodiment of the present invention, the processing module comprises a filter and the first control configures the filter as a filter type selected from a group comprising a complex filter and a real-valued filter based on the plurality of operation modes. Furthermore, the filter characteristic can also be configured according to the plurality of operation modes. In yet another embodiment of the present invention, the ADC is implemented using sigma delta modulation and the sigma delta modulation based ADC can be configured as a complex ADC and a real-valued ADC according to the plurality of operation modes. In still another embodiment of the present invention, the local oscillation frequency can be adjusted according to the plurality of operation modes to cause a zero IF signal or a low IF signal of a desired signal. A programmable control register can be used to provide a first control signal to the first control and a second control signal to the second control based on the plurality of operation modes.

In one embodiment, an integrated multi-standard television tuner is configured to operate in at least one operation mode, wherein the integrated multi-standard television tuner comprises a RF circuit, a mixer, a processing module and an analog to digital converter (ADC). The RF circuit is coupled to receive a RF input signal to amplify the RF input signal. The mixer is coupled to an input signal and a local oscillation signal to provide a mixer output signal, wherein the mixer output signal comprises an in-phase signal and a quadrature signal. The processing module is coupled to receive the mixer output signal having a first control, wherein the first control configures the processing module based on the plurality of operation modes. The ADC having a second control is coupled to receive the signal processed by the processing module, wherein the second control configures the ADC based on the plurality of operation modes.

### BRIEF DESCRIPTION OF THE DRAWINGS

FIG. 1 illustrates conventional system architecture for a multi-standard TV receiver where separate down conversion/analog demodulation modules are used to process different TV standards.

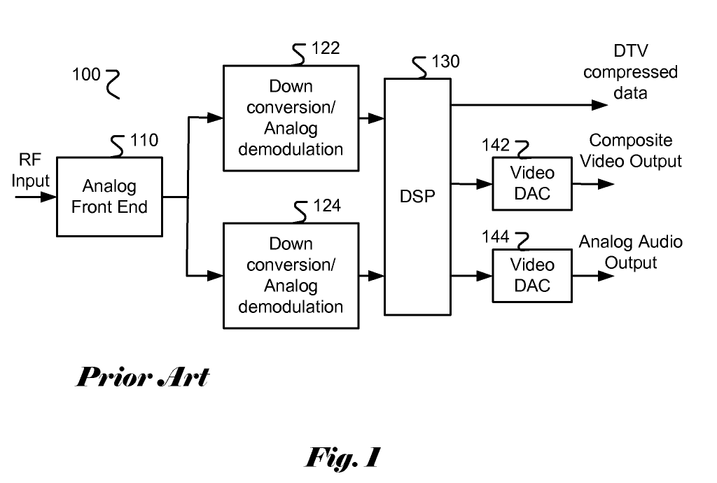

FIG. 2 illustrates an exemplary system comprising configurable modules to receive multi-standard radio signals.

FIG. 3 illustrates an example of configurable processing module for signal filtering according to one embodiment.

FIG. 4 illustrates an example of configurable sigma delta modulation according to one embodiment.

FIG. 5 illustrates the multiple-standard receiver configured to provide complex filtering and real-valued sigma delta modulation.

FIG. 6 illustrates the multiple-standard receiver configured to provide real-valued filtering and real-valued sigma delta modulation.

FIG. 7 illustrates the multiple-standard receiver configured to provide real-valued filtering and complex sigma delta modulation.

FIG. 8 illustrates the multiple-standard receiver configured to provide complex filtering and real-valued sigma delta modulation.

### DETAILED DESCRIPTION OF THE INVENTION

In light of various advantages of digital transmission, many radio systems based on analog transmission technology being replaced by digital transmission systems or the digital transmission system is used to provide additional and improved service. For example, the conventional AM/FM audio broadcasting is being augmented with digital audio broadcasting such as DAB, and HD radio. On the other hand, while analog television channels are still used in some regions, digital TV system that delivers better-quality digital TV programs may be replacing the analog television system or being used simultaneously with the analog television system. It would be advantageous to provide a unified, configurable receiver to receive signals in various standards for convenience and cost saving. When dealing with analog TV channels and digital TV channels, analog TV signals and digital TV signals are processed separately and respectively because analog and digital signals are essentially different in characteristics. In some regions, the present TV products must be able to receive and process analog TV signals transmitted through analog channels as well as digital TV signals transmitted through digital channels, before digital TVs can completely substitute analog TVs. Therefore, often a receiver contained in a TV must have two separate demodulators, one for digital TV signals and the other for traditional analog TV signals. Furthermore, even for the same type of television standard such as PAL, the spectrum bandwidth allocated may be different from region to region. The spectrum bandwidth difference introduces another dimension of design challenge for the multiple-standard television receiver architecture.

There are different design challenges to analog television receiver and digital television receiver. For a terrestrial TV tuner, it is an extremely demanding environment of off-the-air reception due to various potential interfering sources, such as high power in-band TV signals from other TV broadcast stations that the tuner is not presently tuned to, and the out of band interferers such as cellular phone services that are close enough to the UHF TV band. Therefore, the design challenges are the required high image rejection ratio and the required overall low noise figure.

The analog TV signal usually contains a high power carrier signal which may cause noticeable adjacent channel interference. Therefore, the analog TV spectrum allocation plan always avoids allocating two adjacent channels for analog TV transmission in the same coverage area. Therefore, for a selected analog TV channel, usually there is no adjacent analog channel being allocated. On the other hand, the transmitted power level used by digital TV usually is lower than the analog TV signal and there is no strong power concentration near the carrier frequency. Consequently, there is no restriction for allocating two adjacent channels for digital transmission. For a selected digital channel, there may be an adjacent analog channel which can cause strong adjacent-channel interference if the filter is not properly designed. Consequently, analog TV and digital TV receivers impose different requirements on the filter design. Furthermore, analog TV standards such as NTSC and PAL, as well as ATSC digital TV standard are all based on vestigial sideband (VSB) modulation. The spectrum of these VSB modulated signals is asymmetric around the carrier frequency. Accordingly, a complex filter will be needed to optimally recover the VSB modulated signals. On the other hand, DVB-T/H, and ISDB-T digital TV standards used for over-the-air broadcast and the QAM based digital cable distribution have symmetric spectrum around the carrier frequency. Real-valued filters will be sufficient to recover the digitally modulated signals. Nevertheless, complex filters can also be used to correct problems due to certain system impairments such as I/Q gain mismatch.

After the received signals are down-converted and analog demodulated, the down-converted signal has a low IF or zero IF, where the low IF is referring to an IF frequency that is less than five times of channel spacing. The down-converted signal is then subject to digitization, i.e., analog to digital conversion. Often a sigma delta modulation is used because it provides improved perform due to the noise shaping feature. The sigma delta modulation (SDM) comprises an over-sampling digitizer which is often a 1-bit digitizer, and a loop filter to control noise shaping. A high-order filter usually provides better noise shaping capability at the expense of higher complexity. There is also a class of SDM which utilizes a complex loop filter and can cause a Nth-order complex SDM to be as effective as a SDM using 2Nth-order real-valued loop filter. For example, a complex SDM with a 4th-order complex loop filter can have the same noise-shaping response as an 8th-order real-valued loop filter. To achieve the same ADC resolution, a complex SDM requires half of the sample rate as that of the real-valued SDM, thus, the power consumption is much less.

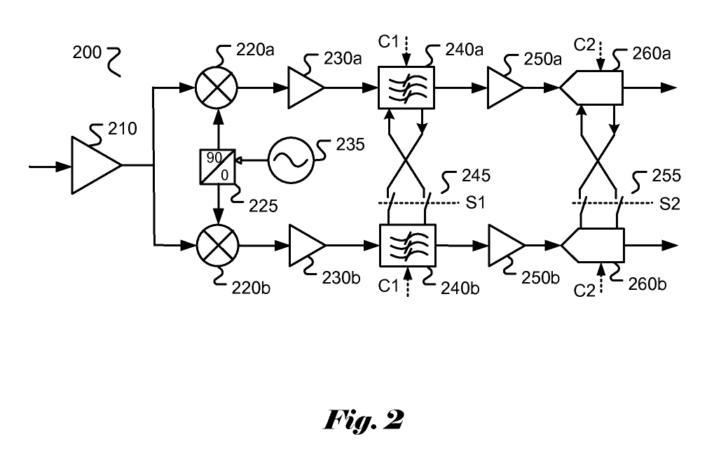

FIG. 2 illustrates an example of one embodiment of multi-standard receiver 200 according to the present invention. The amplifier 210 is coupled to input signal to amplify the input signal. The input signal may be received by an antenna, which is not shown, and processed by an analog front end circuit such as a low-noise amplifier (LNA) and/or a tuning filter, which is not shown either. The amplifier 210 may also be used as the LNA if a LNA is not included in the analog front end circuit. The input signal is then subject to down conversion to shift the signal spectrum to a lower frequency to ease the design challenge for subsequent processing. While FIG. 2 illustrates a one-stage down conversion, a two-stage down conversion may also be used. The present invention is not limited to one-stage down conversion. A pair of mixers, 220a and 220b, are used to mix the input signal with an in-phase and a quadrature local oscillation signals. The in-phase and the quadrature local oscillation signals are generated by the local oscillator 235 and the quadrature generator 225. The upper mixer 220a outputs a down-converted in-phase signal and the lower mixer 220b outputs a down-converted quadrature signal. The down converted signals may be subject to amplification or buffering by the optional buffers 230a and 230b. The subsequent processing will be very dependent on the characteristics of the underlying signals.

An embodiment of the configurable multi-standard receiver according to the present invention comprises a configurable processing module 240 (shown as two units 240a and 240b with a switchable cross connection) which includes a selection control S1 245 and parameter control C1. In one example, the processing module 240 may be configured as a filter, where the selection S1 245 may cause the processing module 240 to function as a complex filter or a pair of real-valued filters. When the filter is configured as a real-valued filter, the in-phase signal and the quadrature signal will use their respective filters 240a and 240b without any cross coupled component from the other signal path. Furthermore, the parameter control C1 will supply the required parameters used to configure the characteristics of the filter such as frequency response and filter bandwidth. For example, a frequency response with stronger interference rejection capability may be selected for receiving digital TV where adjacent analog channels may exist. In another example, the processing module can be configured for TV signal with 6 MHz bandwidth for intended TV reception in one region and with 8 MHz bandwidth for intended TV reception in another region. The processing module outputs may be subject to additional amplification/buffering by a pair of optional buffers 250a and 250b.

After down conversion and properly filtering, the output signals are ready for digitization and further processing in the digital domain. In one embodiment of the multi-standard receiver according to the present invention, a configurable analog to digital converter (ADC) 260 (shown as two units 260a and 260b with a switchable cross connection) is used. The ADC is based on sigma delta modulation (SDM) to take advantage of noise shaping capability of the SDM. In one example, the ADC 260 may be configured as a complex SDM or a real-valued SDM under the control of selection S2 255. When the SDM 260 is configured to have real-valued loop filter, the in-phase signal and the quadrature signal are digitized by their respective SDM 260a and 260b without any cross coupled component from the other signal path. Furthermore, the parameter control C2 provides parameters required to configure the characteristics of the loop filter of the SDM to adjust the noise shaping of the SDM.

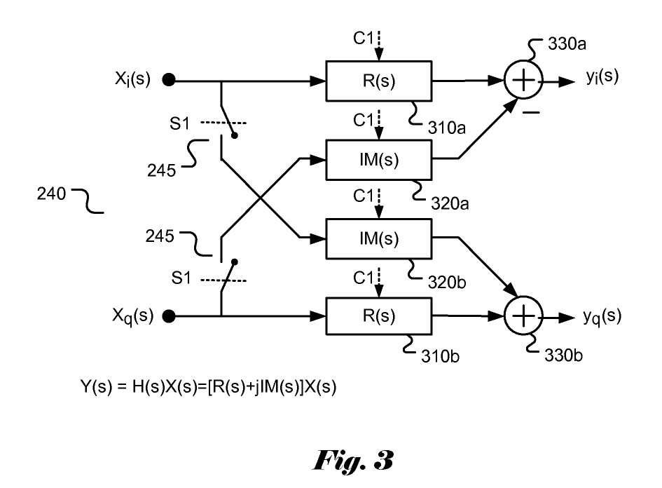

FIG. 3 illustrates an example of configurable processing module according to one embodiment of the present invention, where the processing module is configured as a filter. The transfer function of the complex filter is represented as H(s) and H(s)=R(s)+j·IM(s), where R(s) is the real part and IM(s) is the imaginary part of the transfer function, and s is the Laplace variable. The filter output in the upper path, yᵢ(s), may contain the component related to the upper path input, xᵢ(s), as well as component from the cross coupled lower path input, x_{q}(s). Similarly, the filter output in the lower path, y_{q}(s), may contain component related to lower path input, x_{q}(s), as well as the component from the cross coupled upper path input, xᵢ(s). When the switch S1 245 is in the open position, the cross coupled components are disconnected from the filter, and the filter functions as a pair of real-valued filters 310a and 310b. However, when the switch S1 245 is in the close position, the cross coupled components will contribute to the output signals through imaginary part 320a and 320b of the complex filter, and adders 330a and 330b will combine the respective signals to form the output signals. The parameter control C1 is applied to each of the filters 310s, 310b, 320a and 320b to adjust the filter characteristics such as the frequency response and the bandwidth.

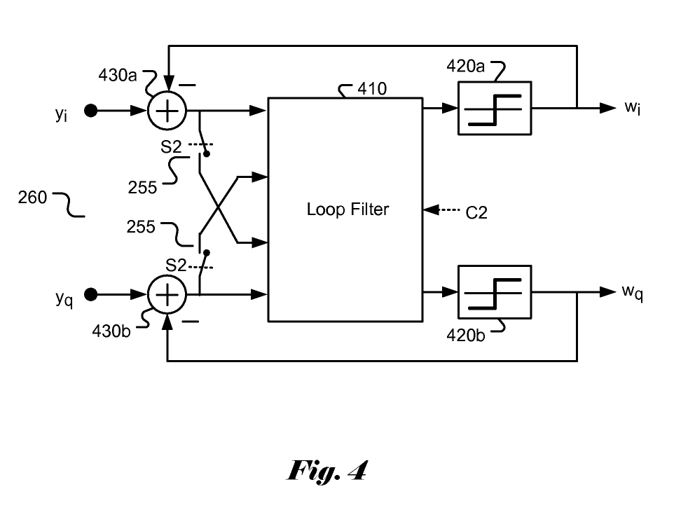

FIG. 4 illustrates an example of configurable ADC according to one embodiment of the present invention, where the SDM can be configured according to the setting of switch S2 255 to use either complex loop filters or real-valued filters. As mentioned previously, the complex loop filter can achieve more effective noise shaping compared with the real-valued loop filter of the same order. The parameter control C2 is applied to the loop filter 420 to adjust the filter characteristics and consequently to affect the noise shaping. When the switch S2 255 is open, the cross coupled components are not used and the loop filter becomes two separate real-valued loop filters. When the switch S2 255 is closed, the cross coupled components are used by the complex loop filter. The loop filtered signals are then processed by digitizers 420a and 420b, where 1-bit high-speed sampling is often used in practice. The digitized signals wᵢ and w_{q} are subtracted from their respective input signals, yᵢ and y_{q} by adders 430a and 430b to form the error signals to be filtered by the loop filter.

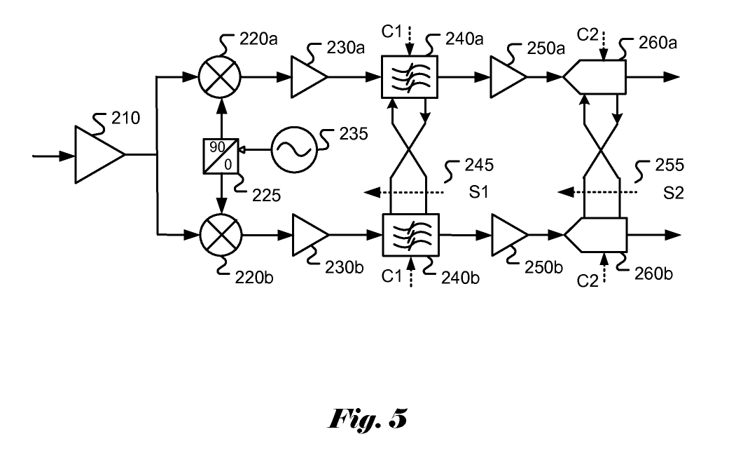

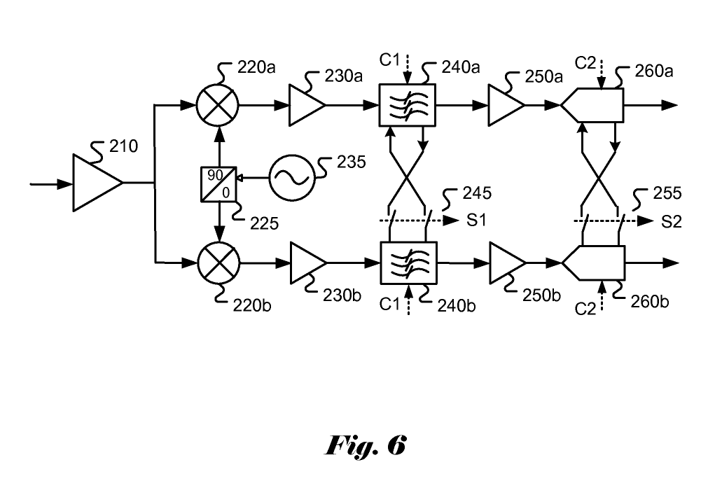

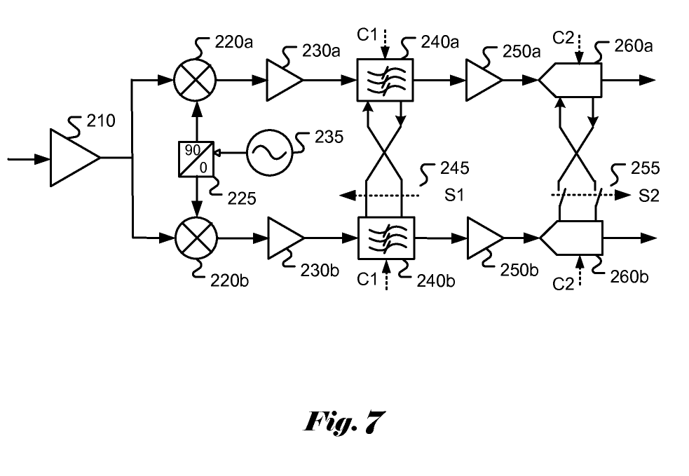

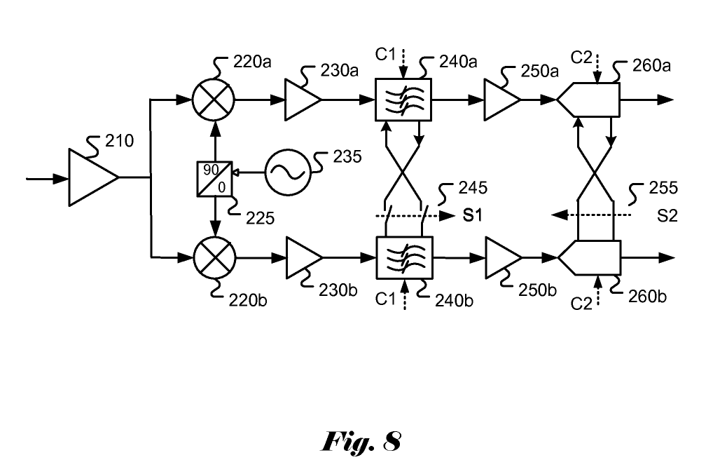

The configurable multi-standard receiver shown in FIG. 2 provides flexibility to support multiple standard signals by sharing most system resources. Such system not only offers the desired convenience, but also avoids high cost of supporting multiple standards. FIG. 5 illustrates an example of system configuration based on the configurable multi-standard receiver, where the processing module is configured as a complex filter and the SDM is configured to have complex loop filter. This configuration may be used to receive an analog TV signal where the signal spectrum is asymmetric around the carrier frequency and a complex filter will effectively recover the modulated signal. The SDM with complex loop filter can properly shape the quantization noise to minimize the visibility of the noise. FIG. 6 illustrates another configuration based on the configurable multi-standard receiver of FIG. 2. In FIG. 6, the processing module is configured as a real-valued filter and the SDM is configured as a pair of SDM having their respective real-valued loop filters. The configuration may be used to receive a digital TV signal. If well balanced mixers are used, the mixer outputs may be substantially free from cross coupling between I and Q components. A pair of real-valued filters may be sufficient. Also, a pair of real-valued SDMs may be sufficient to digitize the filtered signals. The parameter controls C1 and C2 can be properly selected according to the targeted signal to be received. While two examples are shown in FIG. 5 and FIG. 6 for analog TV reception and digital TV reception respectively, different system configuration may also be used for the same TV signal. For example, the system may be configured to have a complex filter and a real-valued SDM to receive an analog TV signal as shown in FIG. 7. However, since the received signal is a Low IF signal, the real-valued SDM will have to be a bandpass SDM which is much less efficient compared with a complex bandpass SDM. Alternatively, the system may be configured to have a real-valued filter and a complex SDM to receive an analog TV signal as shown in FIG. 8.

The setting of switches S1 and S2 and the parameter control C1 and C2 can be pre-designed based on the target signal to be received. The setting may also be adaptively changed by detecting the existence of the signal and related signal characteristics such as the existence of subcarrier frequencies. The setting for S1 and S2 and the parameter control C2 and C2 may be stored in a control register. The register may be located on the chip of an integrated multi-standard receiver or external to the integrated multi-standard receiver.

The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware codes may be developed in different programming languages and different format or style. The software code may also be compiled for different target platform. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A multi-standard radio receiver configurable to operate in a plurality of operation modes, comprising:
a mixer coupled to an input signal and a local oscillation signal to provide a mixer output signal, wherein the mixer output signal comprises an in-phase signal and a quadrature signal;
a processing module coupled to receive the mixer output signal having a first control, wherein the first control configures the processing module based on the plurality of operation modes; and
an analog to digital converter (ADC) having a second control, wherein the second control configures the ADC based on the plurality of operation modes.

2. The multi-standard radio receiver of claim 1, wherein the processing module comprises a filter and the first control configures the filter as a filter type selected from a group comprising a complex filter and a real-valued filter based on the plurality of operation modes.

3. The multi-standard radio receiver of claim 2, wherein the first control further configures filter characteristic of the filter based on the plurality of operation modes.

4. The multi-standard radio receiver of claim 1, wherein the ADC is implemented based on sigma delta modulation.

5. The multi-standard radio receiver of claim 4, wherein the second control configures the ADC as a converter type selected from a group comprising a complex ADC and a real-valued ADC based on the plurality of operation modes.

6. The multi-standard radio receiver of claim 1, wherein frequency of the local oscillation signal is adjusted based on the plurality of operation modes.

7. The multi-standard radio receiver of claim 6, wherein the frequency of the local oscillation signal is adjusted to cause the mixer output signal to include an IF signal type selected from a group comprising a zero IF signal and a low IF signal of a desired signal in the input signal.

8. The multi-standard radio receiver of claim 7, wherein the low IF signal has an IF frequency less than five times channel spacing.

9. The multi-standard radio receiver of claim 1, comprising a programmable control register to provide a first control signal to the first control and a second control signal to the second control, wherein the programmable control register is programmed based on the plurality of operation modes.

10. An integrated multi-standard television tuner configurable to operate in a plurality of operation modes, comprising:
a RF circuit coupled to receive a RF input signal to amplify the RF input signal;
a mixer coupled to receive the amplified RF input signal and a local oscillation signal to provide a mixer output signal, wherein the mixer output signal comprises an in-phase signal and a quadrature signal;
a processing module coupled to receive the mixer output signal having a first control, wherein the first control configures the processing module based on the plurality of operation modes; and
an analog to digital converter having a second control, wherein the second control configures the analog to digital converter (ADC) based on the plurality of operation modes;
wherein the RF circuit, the mixer, the processing module and the analog to digital converter are integrated on a same semiconductor substrate.

11. The integrated multi-standard television tuner of claim 10, wherein the processing module comprises a filter and the first control configures the filter as a filter type selected from a group comprising a complex filter and a real-valued filter based on the plurality of operation modes.

12. The integrated multi-standard television tuner of claim 11, wherein the first control further configures filter characteristic of the filter based on the plurality of operation modes.

13. The integrated multi-standard television tuner of claim 10, wherein the ADC is implemented based on sigma delta modulation.

14. The integrated multi-standard television tuner of claim 13, wherein the second control configures the ADC as a converter type selected from a group comprising a complex ADC and a real-valued ADC based on the plurality of operation modes.

15. The integrated multi-standard television tuner of claim 10, wherein frequency of the local oscillation signal is adjusted based on the plurality of operation modes.

16. The integrated multi-standard television tuner of claim 15, wherein the frequency of the local oscillation signal is adjusted to cause the mixer output signal to include an IF signal type selected from a group comprising a zero IF signal and a low IF signal of a desired signal in the input signal.

17. The integrated multi-standard radio receiver of claim 16, wherein the low IF signal has an IF frequency less than five times channel spacing.

18. The integrated multi-standard radio receiver of claim 17, comprising a programmable control register to provide a first control signal to the first control and a second control signal to the second control, wherein the programmable control register is programmed based on the plurality of operation modes.

19. A method of demodulating a multi-standard radio signal using a configurable receiver having a plurality of operation modes, the method comprising:
mixing an input signal and a local oscillation signal to provide a mixer output signal, wherein the mixer output signal comprises an in-phase output signal and a quadrature output signal;
filtering the mixer output signal using a configurable filter, wherein the configurable filter is configured as a real-valued filter or a complex filter based on the plurality of operation modes; and
converting the filtered mixer output signal into a digital signal using a configurable sigma delta modulator (SDM), wherein the configurable SDM is configured as a real-valued SDM or a complex SDM based on the plurality of operation modes.
